(19) United States
(12) Patent Application Publication
(10) Pub. No.: US 2018/0288673 A1
(43) Pub. Date: Oct. 4, 2018

(54) SYSTEM, METHOD AND APPARATUS ASSOCIATED WITH PRE-EXISTING WIFI NETWORK TECHNOLOGY

(71) Applicant: Damian Henderson, Dallas, TX (US)

(72) Inventor: Damian Henderson, Dallas, TX (US)

(21) Appl. No.: 15/165,849

(22) Filed: May 26, 2016

(51) Int. Cl. H04W 48/02; H04W 12/08; H04W 12/12; H04W 4/02; H04W 48/20

(52) U.S. Cl. CPC H04W 48/02; H04W 12/08; H04W 84/12; H04W 4/025; H04W 48/20; H04W 12/12

(57) ABSTRACT

A software application and system called PEN technology is a combination of wired and wireless network components combined with a series of systematic actions yielding results viewable of the administrator ‘sand subscriber's client devices. When this application is used, it offers a layer of network security, accountability, and efficiency by regulating network access, announces what is accessing the network, transmissions of data using the network, and documentation of actions that are performed by the wireless network users.

### BACKGROUND OF THE INVENTION

The present invention relates to a system, method and apparatus related to wireless networks with regards to the security, accountability, data transfer, and documentation involving administration and subscribers that use wireless networks in a home or business environment.

### DESCRIPTION OF PRIOR ART

Any discussion of documents, acts, materials, devices, articles or the like which has been included in this specification is solely for providing a context for the present invention. It is not to be taken as an admission that any of these matters form part of the prior art base or were common general knowledge in the field relevant to the present invention as it existed in USA or elsewhere before the priority date of this application.

Home and business environments are rapidly moving in the direction of wireless networks. Wireless in these environments networks have made the process of streaming videos, online gaming, or internet browsing easier as Wi-Fi enabled devices are more and more utilized.

Wi-Fi (Wireless Fidelity) has emerged to be a widespread and key technology in the recent past. Many devices including smartphones, laptops, tablets, computers, digital cameras, smartwatches, televisions, etc. use Wi-Fi Technology; can connect to a network resource such as Internet via Wireless Network

Wireless routers and access points offer the use of internet access with convenience of using Wi-Fi enabled devices. Routers offer connection but at the cost of limited range. Hotspots can extend from an area as small as a few rooms to as large as many square kilometers achieved by using multiple overlapping access points. With encryption technologies and protocols like WPA, WPA2 and WPS, Wi-Fi a layer of security is added to internet access.

Not knowing who is connected to the network can have repercussions that may not be easily rectified. Giving access credentials to users require you to reissue credentials every time the password is changed. Other issues include unwanted sharing of the network password, and as well as password users gaining unwanted access. The protocol put into place to govern how commercial and noncommercial consumers utilize wireless networks are more than unsatisfactory and far from efficient.

Unsecured or open networks have detrimental repercussions. Criminals can create wireless networks in buildings to attract unsuspecting people to view information on the person's device. Unsecured or open networks can reduce bandwidth resulting in slower data transfer. These unsecured networks can allow users to view and perform illegal activities; inappropriate websites, perform malicious activities to the wireless network (changing configuration), fraudulent activities, and stolen identity as well as virus spreading

Global Positioning System (GPS) provides way of tracking and navigating to locations. Using GPS can be convenient; allowing many users to utilize smart devices. Since GPS devices rely on satellites, they are not perfectly suited for multilevel structures Interference from dense foliage, increment weather conditions, walls or physical barriers, and multilevel structures can cut communication off when you need it most.

Electronic mail electronic mail, email (or e-mail) is defined as the transmission of messages over communications networks. Typically, the messages are notes entered from the keyboard or electronic files stored on disk. Most mainframes, minicomputers, and computer networks have an email system. While readily available and widely used, E-Mail pose undesirable issues. E-Mails are not efficient. E-mail do not send receive confirmation until the email is opened, not when its received. Email inboxes can become full and be mistaken for spam. E-mail is one of the commonest ways for viruses to travel and infect computers. E-mails can be sent anonymously, which means that they are sometimes used maliciously to bully or upset people. E-mail is susceptible to hacking.

Text messages and multimedia messages offer convenience as well as ease of use. This has proven to be a greatly used way to transmit data. As technology matures, the cost to use this method has dramatically decreased. Issues that are faced with text messages range from verifying the receipt of the message. Text and multimedia but at a sacrifice of limited data transfer and limitations on when the user will receive the transmission. It is not uncommon for mobile device users to experience the inability of receiving messages while being involved on a voice call on the mobile device. The sender can send

and document the messages departure but there is no guarantee the recipient will receive the message. Also, take into consideration the message is time and date stamped by the recipient once the recipient's device is able to receive the data. Powered off devices are bad coverage represent detrimental issues. Communicating using paper has been around for thousands of years. Paper is easily and readily available at little cost. Paper is wide spread and wide used throughout the world. Once data is transferred to paper, the level of confidentiality substantially decrease. Paper handouts or notes are

potentially misplaced and thrown away. The amount of space that paper occupies dramatically decrease the efficiency in area use. More important the carbon footprint used in the manufacturing of paper is overwhelming. 14 million trees are cut down yearly for the manufacturing of paper. In the process of the production of paper bags, thousands of gallons of fresh water and bleach are used to clean the pulp.

Check points or sign in locations is common in regards to documenting and verifying approaching people. It is not uncommon for guest to leave identifications at the front desk when visiting a location. Generally, access or visitor badges are handed out and the identification is returned once the badge is returned. In many cases, time and dates are documented. Issues that arise from this method is there are times when the guest forget to return the badge. This results in a wasted trip back to the location for the guest, costly badge replacement, or identification being misplaced due to a change in personnel at the check in location. There have been documented issues where information on identification has been

stolen by an unwanted onlooker or identification given to the wrong visitor. Allowing visitors to sign in and document their own time sometimes result in confusion or user error.

While wireless networks are accessible, they can be used to expedite processes related to the communication between network personnel and network non-personnel in a more secure and efficient method.

### BRIEF DESCRIPTION OF THE DRAWINGS

The embodiments of the present invention can be better understood with the help of accompanying drawings wherein;

FIG. 1 illustrates a system implementing PEN technology network as an administrator has real time location of the subscriber's client device entering and exiting Access points and wireless networks.

FIG. 2 illustrates a system implementing PEN technology as subscriber's client device receive location specific information.

FIG. 3 illustrates a system implementing PEN technology as an administrator implement administrative permission using a client device as a wireless network.

FIG. 4 illustrates a system implementing PEN technology that recognizes and transmits data to a specific subscriber's client device.

### DETAILED DESCRIPTION

The invention takes full advantage of the wireless client device's MAC Address, personal Information, and images to identify the person and the device being utilized by the administrator/facilitator and the subscriber.

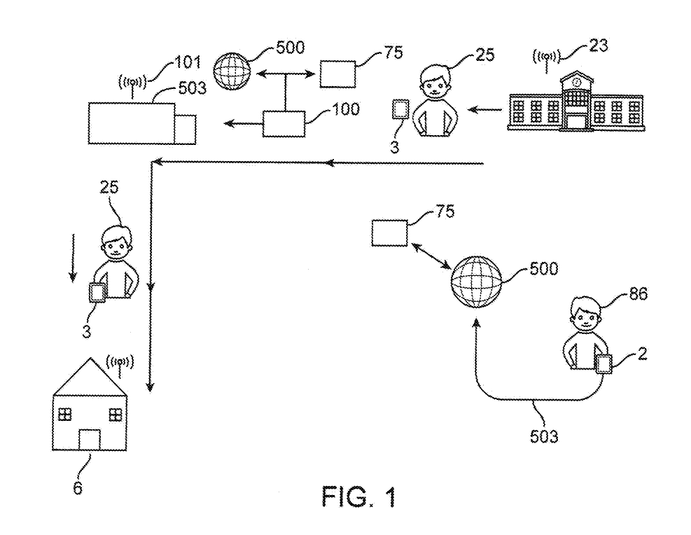

With reference to the drawings, FIG. 1 illustrates a system implementing the Pre-Existing Wi-Fi® network. FIG. 1 represents a subscriber 25, with the subscriber client device 3, leaving a location's wireless network 23. Once the subscriber 25 with the subscriber client device 3, is out of range, an administrator 86, has an administrator client device 2 with permissions related to the network is notified. The administrator 86 is connected to the wireless network 23 via internet 500 for locating the subscriber 25 as the subscriber enters and exits access points. The administrator 86 has the client device

2 that also has administrator permissions for a mobile hotspot 503. The subscriber 25 and the subscriber client device 3 connects to the mobile hotspot 503. The administrator 86 receives notifications on the administrator client device 2 with permissions. Once the subscriber 25 and the subscriber client device 3 reaches home 6. The administrator 86 receives notifications on the administrator client device 2 with administrator permission. All of this is stored on the database 75 that is assessable from the client devices 2,3. The administrator 86 has the administrator client device 2 registered to have multiple wireless network access and permissions.

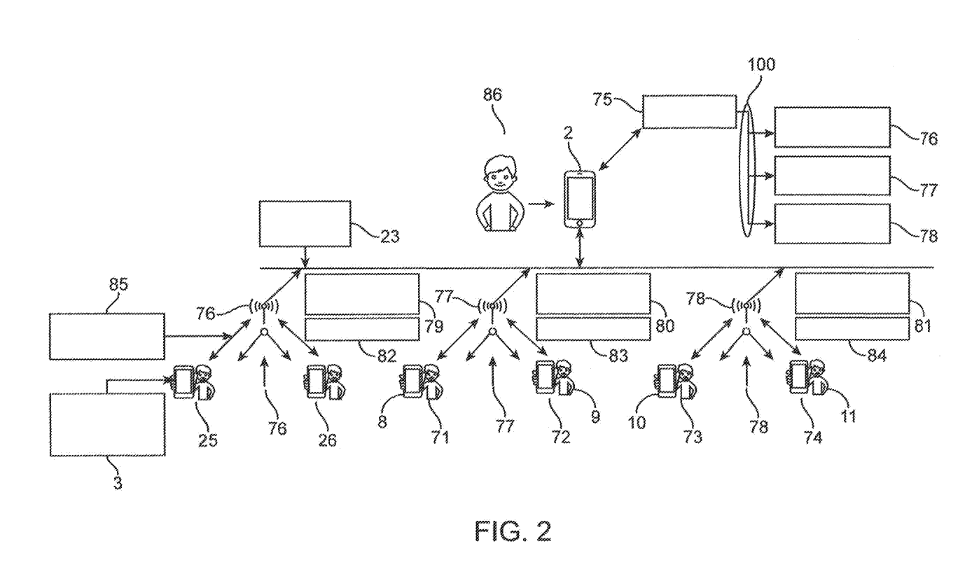

With reference to the drawings, FIG. 2 illustrates a system implementing the Pre-Existing Wi-Fi® network in a location with multiple subscribers and multiple access points. FIG. 2 represent multiple subscribers receiving data based on the Access point in which they are connected. Subscriber 25 is in a specific area in a location. Subscriber 25 is currently on the access point 79 at a location 82 on the wireless network 23 using a wireless connection 85. To maintain a wireless connection, Subscriber 25 is connected to access point 79. The administrator 86 can send data 76 from the administrator client device 2 as it is related to the location 82 Access point 79. Subscriber 26 will receive identical data 76

because subscriber 26 is at location 82 connected to access point 79. Subscriber 71 and subscriber 72 will receive data 77 because both subscriber 71 and subscriber 72 are at location 83 at access point 80. Administrator 86 facilitates this using a administrator client device 2. API 100 retrieve data 76, 77, 78 from the data base 75 and sends it to the subscribers.

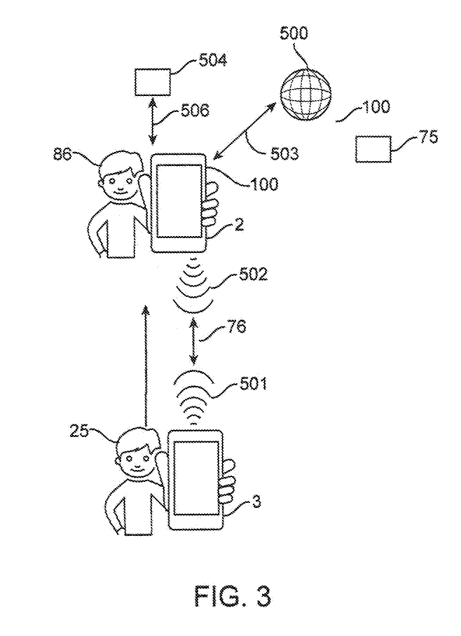

With reference to the drawings, FIG. 3 illustrates a system implementing the Pre-Existing Wi-Fi® network as a administrator 3 uses the administrator client device 2 as a wireless network. Once tethering 502 is activated. The Wi-Fi is disabled on the administrator client device 2. The administrator client device 2 is now connected to the internet 500 as to facilitate providing subscriber 25 a wireless network 2 to connect to. Subscriber 25 approaches with wireless network access on the subscriber client device 3 with Wi-Fi enabled 501. Administrator 86 has a Bluetooth capable device 504 that can receive the notifications that are delivered to administrator client device 2 as it is related to subscriber 25. Notifications related to subscriber 25 can also be received on administrator device 2.

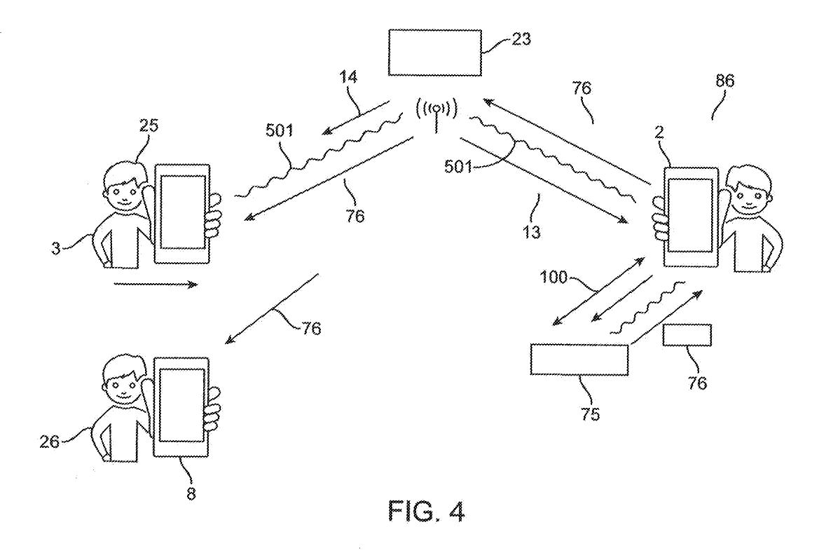

With reference to the drawings, FIG. 4 illustrates a system implementing the Pre-Existing Wi-Fi® network as specific subscribers receive personalized data as the subscriber approaches. End-use 25 approaches wireless network 23 with subscriber device 3. Connection using Wi-Fi 501 is made to the wireless network 23. Administrator 86 receives a notification 13. Subscriber 26 in possession of subscriber client device 8 connects to the wireless network 23. Administrator 86 receives a notification 13. in FIG. 4, data 76 is identical in nature.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. For example, references to Wi-Fi are intended to refer to current 802.11 standards, as well as future variations, including other wireless IP protocols. It is therefore intended that the appended claims be construed to cover all such equivalent variations as fall within the true spirit and scope of the invention.

### SUMMARY OF THE INVENTION

The present invention employs Pre-Existing Wi-Fi® network(PEN) technology that can collect administrator criteria based information from the subscriber's client device and added information from the subscriber, encrypt the collected information, send encrypted information to the network administrator for being validated, and save the subscriber's information for the purpose establishing connection to a wireless network when the technology in reference is initiated. Administrators of the wireless network have the added convenience of approving who has access to the network before the subscriber reaches the wireless network; further removing user error.

Once the registration is complete, the network's administrator verifies entered information and sends status of approval or denial to the subscriber preferred method of communication. This process is done without the subscriber having access to network credentials for added security.

PEN technology allows the wireless network to recognize and connect saved client devices based on the stored information and corresponding PEN technology as the subscriber's client device arrives to the registered wireless network and departs the registered wireless network. Notifications are sent to the administrator client device to alert the administrator of the subscriber's arrival.

PEN technology also employs SPECIFIC TIME AND SPECFIC SUBSCRIBER LOCATION data transferring encryption. Administrator can preset a hotspot, access point, time, and date for data to be transferred to subscribers connected to the wireless network.

When this application is used, it verifies that data was not only sent, but that the data was received in real time as it relates to administrators and subscribers. Furthermore, actions facilitated by the wireless network are documented to ensure a measure of accountability as it relates to all parties involved in situations utilizing the wireless network.

The present invention offers code based software application with custom built APIs that retrieve and input information to the server, database as it relates the wireless network. These custom APIs facilitate the process determining what client device receives what data and administrator permissions.

According to yet another aspect of present invention, the software application and system extends to utilize Smart TV/External Smart devices enabled with Wi-Fi® connectivity to view the real-time footage and proximity/location of the vendors connected to the network. For example, once the subscriber gains access to a PEN network, all calendar scheduled activities and other details are downloaded to the end user's device and added to the calendar and or document folder.

The present invention, when initiated offers code based software applications which the software application uses encryption to transfer data utilizing Wi-Fi, VOIP, VOLTE etc. Documentation of the transactions are stored securely. Security protocol involves specific time and specific subscriber location data transferring encryption. The security functionality of the device that is being used plays a role as well. Furthermore, making size of the carbon footprint substantially smaller. Adapting to the

ever-changing landscape of mobile device technology, the invention puts the control of the conveniently in the immediate proximity of the users of the invention; bridging the communication gap of users of this invention. While wireless networks are accessible, they can be used to expedite processes related to the communication between network personnel and network non-personnel in a more secure and efficient method. The invention takes advantage of the wireless router as a security

measure that other invention considers not so secure. Hence, all abovementioned points render present invention as a substantial improvement over prior art in this field. The present invention is ahead of other technologies and methods due the fact that it is reliable, economical, ecofriendly, secure, efficient, and cost effective since it does not require the subscriber to have any active wireless carrier data package.

What is claimed:

1. A system, method and apparatus associated with Wi-Fi® technology called Pre-existing wireless networks technology (PEN) that uses wireless network components, display capable devices, Wi-Fi® technology, wired network components, server technology, API's, databases, administrative client devices, subscriber client devices, and the internet to facilitate the medium between the wireless networks' administrator and subscribers:
Wherein the wireless networks' administrator's client devices connect to wireless network components and the internet to initiate a series of security protocols that register, validate, facilitate wireless network connection, and systematically control the process of registering, announcing, communicating, and documenting correspondence and the, transactions, and the arrival of subscriber's client devices to the wireless networks' administrator's client device(s).

2. A system, method and apparatus per claim 1, wherein the software application and system by agreement of the wireless networks' administrator accesses, autofill, and stores the administrators wireless network credentials including but not limited to the structure's defined as (standing, moving, floating, flying, gliding, submerged, embedded, implanted) wireless networks' SSID, passwords, information associated with the location's Access point(s), and administrator's client device information; for registering and configuring the administrator's client device and wireless network.

3. A system, method and apparatus per claim 1, wherein the software application and system, if granted access, extends wireless network availability for the subscriber's device without divulging or storing wireless network passwords to the subscriber's client device.

4. A system, method and apparatus per claim 1, wherein the software application allows the wireless networks' administrator's client device to securely grant or deny administrative permissions to other wireless networks' administrator's client devices with administrative network rights on shared wireless networks.

5. A system, method and apparatus per claim 1, wherein the subscriber allows the registration process to autofill and stores the subscriber's client device's MAC address, client device specific information, storage of personal information and media related to the subscriber to be collected using data encryption method for communicating using specific wireless networks to authenticate the subscriber's client device, configure the subscriber's client device for registering the subscriber's client device(s).

6. A system, method and apparatus per claim 1, wherein subscriber's use subscriber client devices to search and request access from administrators of wireless networks.

7. A system, method and apparatus per claim 1, wherein request for wireless network access and approval encrypted notifications are sent and received to the subscriber's client device(s) and administrator's client device(s).

8. A system, method and apparatus per claim 1, wherein the administrator of the wireless network can use the administrator's client device to terminate, disable, or time restrict wireless network access of subscriber's client device.

9. A system, method and apparatus per claim 1, wherein the subscriber can use the subscriber's client device to remove the subscriber's client device from the wireless network of the wireless network administrator.

10. A system, method and apparatus per claim 1, wherein the subscriber's client device can connect to a wireless network once the subscriber's client device is in the proximity of the wireless network to initiate a first subscriber arrival/departure-first subscriber gets recognized protocol.

11. A system, method and apparatus per claim 1, wherein the wireless networks' administrator(s) client device(s) receives notifications of a subscriber(s) client device(s) connecting to the wireless network.

12. A system, method and apparatus per claim 1, wherein the wireless networks' administrator's client device receives detailed notifications as the subscriber's client device disconnects from the wireless network for reasons other than proximity issues.

13. A system, method and apparatus per claim 1, wherein subscriber client device actions and the networks' administrator client device actions are documented.

14. A system, method and apparatus per claim 1, wherein the subscriber's client device and the networks' administrator's client device receive wireless network facilitated notifications regarding wireless network transactions regarding all transaction related parties.

15. A system, method and apparatus when using Wi-Fi® technology called Pre-existing wireless networks technology (PEN) that uses wireless network components, display capable devices, Wi-Fi® technology, wired network components, cloud server technology, API's, databases, administrative client devices, subscriber client device, and the internet to facilitate the medium between the wireless networks' administrator's and subscribers:
Wherein authorized subscriber's client devices and wireless networks' administrator's client devices connect to wireless network components and the internet can facilitate the process of the wireless networks' administrators transferring data to the subscribers utilizing administrator's client devices and subscriber's client devices.

16. A system, method and apparatus per claim 15, wherein the wireless networks' administrator uses the administrator's client device to target specific subscriber's client devices for summoning and transmitting secured data to the subscriber's client device.

17. A system, method and apparatus per claim 15, wherein subscriber's client device receives Access point location specific secured data from the wireless networks' administrator facilitated by the wireless networks' administrator client device based on what Access point the subscriber's client device is connected to.

18. A system, method and apparatus per claim 15, wherein time or date sensitive data that is sent to a specific subscriber's client device is stored to the subscriber's client device's calendar or folder.

19. A system, method and apparatus when using Wi-Fi® technology called Pre-existing wireless networks technology (PEN) that uses wireless network components, display capable devices, Wi-Fi® technology, wired network components, cloud server technology, API's, databases, administrative client devices, subscriber client device, and the internet to facilitate the medium between the wireless network administrator and subscribers:
Wherein authorized subscriber's client devices and wireless networks' administrator's client devices connect to wireless network components and the internet can facilitate the process of the wireless networks' administrators transferring data to the subscribers utilizing administrator's client devices and subscriber's client devices.

20. A system, method and apparatus per claim 19, wherein administrator's client device can govern multiple wireless networks simultaneously.

21. A system, method and apparatus per claim 19, wherein an administrator's client device can govern one or more networks while simultaneously being a subscriber client device on another wireless network.

22. A system, method and apparatus per claim 19, wherein an administrator's client device with tethering capabilities can become a wireless network and govern itself with functionality as if said device was connected externally as an administrator of a separate wireless network.
